(19) United States
(12) Patent Application Publication
(10) Pub. No.: US 2025/0252426 A1
(43) Pub. Date: Aug. 7, 2025

(54) METHOD AND SYSTEM FOR TYING PHYSICAL ASSETS TO DIGITAL ASSETS AND OWNING AND MANAGING THE SAME

(71) Applicant: THE FINE ART LEDGER, LLC, Venice, CA (US)

(72) Inventor: Samuel MILLER, Venice, CA (US)

(73) Assignee: THE FINE ART LEDGER, LLC, Venice, CA (US)

(21) Appl. No.: 18/982,788

(22) Filed: Dec. 16, 2024

Related U.S. Application Data
(60) Provisional application No. 63/549,641, filed on Feb. 5, 2024.

(51) Int. Cl. G06Q 20/36; G06Q 40/06; H04L 9/00

(52) U.S. Cl. CPC G06Q 20/3672; G06Q 40/06; H04L 9/50; G06Q 2220/10; H04L 2209/56

(57) ABSTRACT

A method and system for tying physical assets to digital assets and managing the same, wherein the method includes entering user and physical asset information into a mobile device or computer application, associating a near field communication or other device or identifier with the physical asset and uploading this information via an application to a blockchain ledger to mint a non-fungible token containing asset information surrounding the physical asset's ownership, condition, provenance, documents, records, content, resale rights and the like. The non-fungible token is tied in an asset register to the asset for management of the physical asset, enabling owning, controlling, authenticating, cataloguing, inventorying, promoting, and trading, as well as data aggregation regarding user preference in the assets they hold.

### CROSS-REFERENCE TO RELATED APPLICATION

This application claims priority benefit of U.S. provisional application No. 63/549,641, filed Feb. 5, 2024, the disclosure of which is incorporated herein by reference in its entirety.

### FIELD OF THE DISCLOSURE

The present disclosure relates to the field of authenticating and tying physical assets to non-fungible tokens (NFT) records and transactions documented within a blockchain and storing those records in digital wallets. Further, the present disclosure relates to a system, method, and software application, which ties physical or digital assets to NFTs and blockchain records and transactions, and which uses NFTs as the core component or repository of information for authenticating, owning, cataloging, inventorying, managing, promoting, and buying and selling physical or digital assets. The system, method, and software application may utilize mobile or web applications or digital wallets for authenticating, owning, cataloging, inventorying, managing, promoting, and buying and selling physical or digital assets, while preserving the underlying tie between the physical asset or digital asset and the NFT, blockchain record, and dynamic content integrated with the underlying asset, using NFTs as the core component or repository of information. It is the use of NFTs as the means of owning, authenticating, cataloging, inventorying, managing, promoting and buying and selling physical or digital assets which is the core feature of this system, method and software application.

### BACKGROUND

Artwork authentication has been a historically challenging task. Traditionally, authentication has required the knowledge of scholars, experts, and masters of the art trade. With the recent introduction of digital NFTs, digital artwork has been more easily transferred from person-to-person. An NFT for the purposes of this disclosure is a transferable and immutable controllable electronic record which is housed or exists on a decentralized network or protocol, whether or not tied to a decentralized or centralized filing or similar system containing or referencing information about the physical or digital asset to which it is associated, otherwise known as the NFTs ‘metadata’. The blockchain has provided a highly visible and transparent ledger for users to track and monitor the purchase history of NFTs and to authenticate the NFT, by reference to the ledger.

Current methods in this field of authentication, such as U.S Published Patent Application No. 2002/0239495, published Jul. 28, 2022, primarily discloses procedures for creating digital certificates of authenticity (COA) which can be uploaded or stamped into the blockchain ledger for an object, such as a work of art, collectible, or NFT. More specifically, U.S Published Patent Application No. 2002/0239495 is based on the release and production of various public and private codes. These codes or other information or data used in combination with each other may be used to compile or create a COA. The COAs may fall into a variety of tiers based on the pluralities of authentication endorsements. Ultimately this type of patent serves to create COAs which use these codes, data or information stored in the blockchain, which COAs may then be associated with an NFT or other type of asset and used to authenticate the NFT, and in turn, the asset associated with the NFT.

Creating tiered COAs is complex and cumbersome, and relies, at least primarily, on recording or stamping into the blockchain these codes, information or data concerning the NFT or underlying digital asset, and then drawing and compiling the information required to produce a COA, which is, at best, tenuously connected to the NFT or other asset to which it relates. This is a redundant process considering that the usual way NFTs are structured and stored entails that they are already associated with metadata which can store all or most of the information needed to authenticate the NFT or the underlying asset with which it is associated.

For example, in the case of art, the NFT itself is better used as the means or reference of retrieving the information required for a COA and using the NFT metadata as the information source itself obviates the need to store further transactions on the blockchain to record or make immutable the information needed to compile the COA. Furthermore, the metadata, is, by definition, either on-chain or otherwise tied or linked to the NFT itself, making the connection between the information comprising the metadata implicitly connected to the NFT or asset to which it relates.

Additionally, an NFT, being a controllable electronic record registered on a distributed ledger, is, by its nature transferable, peer-to-peer, wallet-to-wallet or through centralized marketplaces, exchanges, asset registers or other platforms. Since its metadata is implicitly tied to the NFT, the metadata and information that comprises it, also transfers with the NFT. This immutable and transferable character of NFTs then not only provides novel opportunities for authentication of underlying physical or digital assets as the NFT or asset is transferred from person to person, but also provides novel systems and methods for owning, cataloging, authenticating, inventorying, managing, promoting, and buying and selling physical or digital assets. This is because the NFT is, or can be, itself, the repository of the information concerning not only the NFT and its associated assets but also be written as an instrument of ownership in the underlying asset with which it is associated.

Blockchains, by definition, provide an immutable, transferable record of ownership or provenance in an underlying asset. This can be a digital or physical asset. When the NFT is transferred, the blockchain transaction recording the transfers references the wallet address from, and to which the transfer is made creating a history of ownership or ‘provenance’ in the NFT immutably stored in the series of blockchain ‘block’ transactions, tied and referenceable to one another.

Accordingly, the blockchain itself will track the transfers of ownership in the NFTs, and when the NFT is written as an instrument of ownership in that underlying asset, it, in itself, provides an immutable, transferable and verifiable reference of ownership in the underlying asset.

NFTs have traditionally, for the most part, been seen as associated with digital assets. This has included digital images, video clips and music clips. The resolution of the ‘Double-Spend’ conundrum associated with digital assets, the immutability, transferability and ability to authenticate a digital token or its associated metadata (referencing, or linked to the digital image, clip or music) has made blockchain hosted NFTs synonymous with digital assets, so much so that the general public understanding of NFTs has become to be indistinguishable from the digital assets they reference, with the term ‘NFT’ having become generic for digital art.

A reason for this may be that digital assets are more readily attached to NFTs as they can be digitally stored or referenced in the NFT itself, on chain or off-chain. Usually, the digital image, video or music clip is held off-chain, and referenced as a link in the NFTs metadata, with the image or clip either stored or filed centrally or de-centrally. With physical, real-world assets, for example, an oil painting, desk or chair, there is a separation between the NFT and the underlying physical asset to a further degree, with one (the NFT) existing digitally and the other (the oil painting) existing physically. The inability, to now, of adequately bridging this separation with physical assets and tying the physical asset to the digital NFT has largely left the general perception of NFTs limited to digital assets.

However, this immediate association of NFTs with digital assets belies the additional, and more wide-reaching benefits that NFTs can provide for not only digital assets but also real-world, physical assets.

While associating digital assets with NFTs is prior art, perceiving and rendering the NFT as an instrument of ownership, securely tied to the underlying asset is not. A system and method is required to facilitate the bridge or connection between the NFT and the underlying asset. While, in truth, most digital assets associated with NFTs do not exist ‘on-chain’, but rather in, or referenced in the NFT metadata linked to the NFT, authenticating digital assets as the ‘authentic artifact’ associated with the NFT is easier. Physical, real-world assets are not capable of existing on chain or being ‘held’ in NFT metadata.

Accordingly, a means, system and method of verifying and authenticating that the physical, real-world asset is indeed the asset referenced in, and represented by the NFT, for managing the separation between the digital NFT and the physical underlying asset, and for tying the underlying asset to the NFT are additional embodiments of this Disclosure.

Since an NFT is a controllable electronic record, it can be written to provide for, or store a diverse array of information and apply to a diverse range of applications, in addition to being an instrument of ownership in the underlying asset.

Since the NFT metadata can be written to include a wide variety of attributes or descriptions concerning the asset to which it relates, writing into the metadata the attributes or description of the underlying physical assets and using that information as the source of the information for a COA to authenticate the underlying asset, whether digital or physical, is a further novel use of NFTs in which the NFT itself is the immutable repository of the information concerning the underlying asset, and not the asset itself.

In this way, and as referenced above, each line item of the COA itself describing the underlying asset is available, for the most part, directly from the NFT itself, and not from separate codes or other information separately, and apart from the NFT, stored on the blockchain. When compiling the COA, through a centralized or decentralized application, what is being pulled is the information stored in the NFT itself and, in relation to ownership and provenance of the NFT, the blockchain transaction record, which is publicly viewable on any blockchain explorer.

For example, in the case of art, it could be the name of the artist, and the artwork, its size, medium, edition number or series. These are the information items which may go into a traditional fine art COA. Here they are immediately populated without the cumbersome or complex need to pull separate data points from the blockchain to compile the COA, as is the case under the prior art. With the new method and system being an embodiment of this Disclosure, the COA is simply populated from the information stored in the NFT metadata or derived from the publicly available blockchain transaction data.

What is needed is a system, method and software that allows for the minting of NFTs associated with underlying physical or digital assets that writes the NFT metadata as an instrument of ownership in the underlying asset and pulls the information from the NFT and publicly available blockchain transaction record and populates that into a COA which itself is tied to the underlying asset, all of which are further embodiments of this disclosure.

Since NFTs are transferable, the information itself stored in it or by reference to blockchain transactions is transferred on transfer with the NFT.

Once the NFT metadata is extracted or populated into the wallet of the transferee, or the account of the transferee on a centralized or decentralized platform (for the purposes of this Disclosure, each is referenced as a ‘wallet’), the metadata can be extracted and populated to provide the information concerning the asset to which the NFT relates. Moreover, since the NFT is transferable, this information can be populated or compiled in any NFT transferees wallet, making the COA inherently transferable and without the need to separately pull and compile the COA information points separately stored, or stamped into the blockchain or to make the COA itself transferable through a centralized application or otherwise, as may be required under the prior art

With this in mind, referencing the NFT, or its metadata, itself, provides a novel means of simplifying, and making more efficient the management, cataloging and inventorying of underlying digital or physical assets.

One can view each NFT as a separate catalog or inventory item which when brought together with other NFTs storing information of associated assets produces an inventory or catalog list that is neatly stored in the holder's wallet. Each inventory or catalog entry is immediately and fully available to the owner of the asset in his or her wallet or account.

Traditionally, assets have been inventoried or catalogued using separate spreadsheets or centralized inventory or catalog software or platforms. The use of NFTs as the source and primary component of the catalog or inventory entry not only can obviate the need for separate inventory or catalog lists but also renders the catalog and inventory entries immutable, authentic and transferable.

For example, if one were to have NFTs associated with key personal property in your home, for example, a TV set, a refrigerator or a chair, one can easily hold, catalog and inventory all of those assets in your mobile or desktop wallet. All of your material personal property, and each of their details, could be available to you, neatly kept as NFTs in your wallet.

A centralized or decentralized system that facilitates the connection or link between the NFT, stored in a wallet, and the underlying assets, presents and provides opportunities to aggregate data of wallet holder preferences which may be used for advertising or other commercial purposes.

Similarly, since the blockchain transactions provide an immutable and easily traceable system for ownership, and provenance in the NFT, so does it provide the ability to pull and populate information relating to ownership and provenance in underlying digital or physical assets into a COA, which provides opportunities to use the NFT to verify not only the asset itself but also the ownership of that asset and the information relating to that asset.

Using NFTs in this way also provides the opportunity to change how underlying assets are inventoried.

Prior art involves using separate spreadsheets or digital platforms or applications to identify and list the asset, which spreadsheets and platforms are divorced or separated from the underlying asset itself. Identifying the underlying asset and associating it with its inventory list is done physically (through labels) or electronically (through barcodes, QR-Codes or the like). These inventory lists are static and centrally controlled. When an asset in the list is sold, it is marked as no longer being in that inventory, and would, for example, be manually or electronically entered into the inventory list of the buyer (for example, in the case of a wholesaler's sale to a retailer).

However, the ability to use, and associate an NFT, organized as a transferable catalog or inventory entry in a digital wallet, with an underlying asset provides an immediately referenceable inventory or catalog entry tied to that wallet which can be integrated into, but does not need a centralized inventory or catalog list. That inventory or catalog entry is automatically populated into the buyer's inventory or catalog in his wallet or a centralized platform, building that inventory or catalog as more NFTs representing underlying assets are transferred into the buyer's wallet.

Moreover, with the system, method and software the subject of this Disclosure, the owner of the asset can verify and display the COA and other information relating to the asset by interacting with the asset using a mobile phone to associate and verify the asset as the asset referenced in the NFT.

Using the NFT as a novel instrument of ownership in, or a novel means of cataloging, inventorying, managing, authenticating, promoting and buying and selling underlying assets requires the underlying asset to be robustly tied to the NFT.

To comprehensively identify, and connect the underlying asset with the NFT and its user a system, method and software is required to: (a) manage the NFT and the underlying asset to reduce the opportunity for the NFT and the underlying asset to be separated; (b) associate and tie the underlying asset to the NFT; (c) associate the anonymous blockchain transaction and wallet address with a named owner of the NFT and the asset; and (d) verify the underlying asset as the asset referenced in the NFT, all of which comprise embodiments of this Disclosure.

With reference to [0031], traditional NFT Marketplaces do not cater for physical assets. They are single-tier platforms accessible through user wallets with digital assets either on chain or tied to the NFT through a link to the NFT metadata. Even if an NFT associated with an underlying physical asset were added to an NFT Marketplace, the general interface and features displaying the NFT descriptions would not, beyond, a static reference to the association of the NFT with the underlying asset, be capable of controlling that underlying asset or keeping it associated with the NFT. In some cases, NFT marketplaces simply have features to offer the underlying physical asset as an ‘unlockable’ accompaniment to the NFT, but here the original artifact being authenticated on the blockchain as an NFT is a digital asset. In existing NFT marketplaces, the physical asset isn't tied to the digital asset and is simply in most cases given as an ‘unlockable’ complimentary item.

A system, method and software are therefore required, and as the subject of this Disclosure, provide the features and facilities to tie underlying physical assets to the NFT. This includes displaying the underlying assets' physical identifiers, providing direct access to the underlying assets' COA, and specifically designing the NFT metadata to express that the original artifact being authenticated and tied to the NFT is a physical underlying asset (rather than just an image or other digital representation of it, as is the case in traditional NFT marketplaces), that the NFT token is an ownership interest in the underlying asset and its digital image simply a means of referencing the underlying asset, providing for the underlying physical asset to be identified and verified through a ‘mobile phone experience’ using the user's phone by physically interacting with the underlying asset, and connecting with the second-tier of the platform where the underlying asset is registered and cataloged in the user's account (the “Register”).

Having a two-tier platform, the Register, and additionally, a marketplace specifically geared to minting, and buying and selling underlying physical assets (the “Marketplace”), provides for a novel and better means not only of managing the underlying physical asset and tying it to the NFT but also provides a means of verifying the underlying asset and providing comfort that the asset exists, is unique, the original artifact and is what it purports to be. One further embodiment of this Disclosure is the use of features and facilities in the Marketplace to provide for the checkout in purchasing, and paying for the asset using user digital wallets, including features and facilities geared to underlying physical assets, for example, the payment of tax, shipping, customs and insurance costs on the underlying asset.

The Register has its own NFTs, which are minted separately when the underlying asset is registered on the Register. These NFTs (the “Register NFTs”), when minted, are held in the platform's wallet and not minted to the wallet of the user. Nevertheless, the beneficial ownership in the underlying physical (or digital) asset is blockchain mapped to the NFT such that when the user transfers the NFT, the mapping is updated as a transaction on the blockchain and the Register no longer holds the NFT on behalf of the transferor, but rather the transferee.

The Register includes a comprehensive dashboard where each user catalogs his artworks (the “Register Dashboard”), and where the COA, populated from the NFT metadata and the blockchain transaction for that NFT, is contained. The COA also contains, among other features, the name of the owner of the NFT (as the blockchain mapping to the Register NFT is associated with the Register's centralized database of users), the NFT provenance (as the blockchain transactions in the NFT are associated with the user database), the discrete, and specific asset identifiers with which the underlying asset has been registered on the Register (the “Asset ID”), and the blockchain-specific details, including the smart contract address, and token ID (the “Blockchain Details”).

The COA accordingly brings together the Blockchain Details (of the NFT) and the Asset ID (of the underlying physical asset).

When the Register NFT is transferred, it is transferred into the Register Dashboard of the transferee and catalogued in his collection. The COA is updated and the transferee is reflected as the owner, with the transferor becoming a previous owner and included in the provenance. In this way, the Blockchain Details follow the underlying asset.

The Register Dashboard also allows the user to associate rich content with the NFT and the underlying asset. This is facilitated by having each asset on its own, discrete URL. Each URL is tied to the NFC Tag for the specific artwork. The Rich Content includes, but is not limited to, audio, video, images, links to other websites, ‘buy-now’ or other buttons, documents, and augmented reality experiences (the “Rich Content”). The Rich Content is centralized data.

To further associate the NFT with the underlying asset, the Register runs an API to a centralized database and software system which associates the data in the user's Register Dashboard (including the COA) with the underlying, physical asset. It does this by connecting a physical NFC Tag containing the Asset ID, asset serial number and other identifiers and displaying the Rich Data and COA on its own, unique URL (the “Mobile Experience URL”) whenever there is an interaction between a mobile phone and the NFC Tag.

In this way not only does the mobile phone-asset interaction serve to connect the NFT with the physical asset and generate a blockchain-authenticated, and real-time COA for the asset, but also allows for the display of the Rich Content in the Mobile Experience URL, which can be used to promote, or educate about the asset. The URL may be tagged and pixeled or otherwise track user interaction for use in drip campaigns, retargeted or targeted marketing or other interactions with the asset viewer, providing a means of promoting and marketing the asset or other information.

The NFC Tag includes security measures by which the software system can identify a physical, in person interaction with the NFC Tag. Included in the identifiers associated with the NFC Tag is the discrete Mobile Experience URL. The Mobile Experience URL is designed so that if it is copied or otherwise extracted from, or through an interaction with the NFC Tag, the Mobile Experience URL will time out and not display the Rich Content or COA, thus providing a measure of security preventing duplication of the Asset ID and other physical asset identifiers.

The Register and the Marketplace comprise the two-tier system (the “Two-Tier System”). Each artwork minted in the Register can be listed in the Marketplace. Listing in the Marketplace results in the minting of an NFT, separate, and additional to the Register NFTs. The Marketplace NFT (the “Marketplace NFT”), unlike the Register NFTs, is minted directly by the user and held, and transferred through the user's wallet. The Marketplace NFT may be minted on a choice of blockchains offered by the Marketplace, which may be different to the blockchain on which the Register NFTs are minted.

The Marketplace NFT is connected to the Register NFTs for each individual artwork. This may be achieved through one or more of the use of APIs, metadata content and structure, threading the Marketplace NFT details, such as smart contract address, Token ID and other parameters through to the COA generated in the Register, and authenticated with each mobile phone interaction with the artwork, and other elements, features, or applications. In this way, the COA produces an authenticated record on each art interaction of not only the Asset ID, the Blockchain Details of both the Register and Marketplace NFTs but also the metadata content of each NFT, drawn from each NFT itself.

On a sale of a Marketplace NFT, the Register is automatically updated to reflect the buyer as the new owner on the Register, with the mapping of the connected Register NFT being updated on the blockchain as now held by the buyer.

The Marketplace NFTs are designed, and their metadata constructed so that each NFT that is tied to an underlying physical asset represents not only an ownership interest in the underlying asset but the right for the buyer on purchase to take delivery of the underlying physical asset (the “NFT Instrument”).

The NFT Instrument is freely transferable and negotiable in the Marketplace and acts much like documentary credits in a CIF or C&F commodities sale where the documents (for example, a bill of lading and commercial invoices) behave as title documents to underlying cargo or goods. Having an NFT Instrument allows for the system and method, as herein described, of providing digitally for ‘chain’ or ‘back-to-back’ sales of underlying assets, being bought and sold through intermediaries separate from the initial or ultimate buyers and sellers. The system, method and software can provide for the underlying physical asset to be held for a certain period of time while the Marketplace NFT changes hands, with delivery to the ultimate buyer or for the asset to be kept in a vault by the platform or a third party. For example, replicating high-value artwork sales where the asset changes hands among multiple dealers in a chain before being delivered to an art collector (buyer), Marketplace NFTs, as ownership interests in the underlying physical artwork, can be an authenticated means of anonymously trading the physical art on the blockchain.

As stated above, through this method, system and software, the buying and selling of NFTs in the Marketplace provides for the update of the ownership in the underlying physical asset, as controlled through the Register.

The need for the Register, at least initially, to be centrally controlled (with the platform being the registered owner of the Register NFTs), is further borne out by the need to regulate or adjust for physical assets that become disconnected from their Register or Marketplace NFTs and to have mechanisms in place where a rightful buyer holding the physical asset can claim the Register NFT associated with that asset or, conversely, stake its claim to the physical asset having acquired the Marketplace NFT for the asset.

The present disclosure also includes a means, method, system and software for creating a ‘universal’ blockchain authenticated catalog of assets, for example, fine art. Each catalog entry is tied to the NFT. On transfer of the NFT, the catalog entry is transferred. Each catalog entry by reference to its connected NFT and/or discrete asset URL can be tied, or incorporated into existing asset inventory registers, systems or platforms through API's or other means. The transfer of the NFT facilitates the transfer of the catalog or inventory entry allowing for easy and efficient updates to the transferee's catalog or inventory system, with each NFT representing a superseding, ‘universal catalog’ that can be tracked and authenticated across inventory systems, and each NFT, being a ‘building block’ of that catalog.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope or extent of the appended claims. Its sole purpose is to present some concepts of the example embodiments in a simplified form as a prelude to the more detailed description to follow. It is to be understood that both the following general description and the following detailed description are exemplary and explanatory only and are not restrictive.

A further embodiment may be the use of the NFT itself or the NFT Metadata as the means of owning, inventorying managing, authenticating, promoting, controlling, buying or selling the underlying asset, whether digital or physical. This is novel as one is not treating the NFT itself as the object or underlying asset but as an ownership interest in, and vault of information for the underlying asset.

A further embodiment may be the generation of a digital or hardcopy COA for the underlying asset, whether physical or digital, using, and comprising the NFT itself. The COA is not, in this method and system, a separate digital instrument or set of data stored on the blockchain and linked to the NFT, but rather, in essence, the NFT itself.

A further embodiment may be a method for owning, managing, authenticating, promoting, selling, buying, cataloging, inventorying and tying physical assets to non-fungible tokens, blockchain transactions, authentication and rich-content records or other data, principally contained, themselves, in the NFT or its corresponding metadata or otherwise centrally associated with the NFT or publicly available on the blockchain to deliver experiences relating to the asset. In another embodiment, the data may include the date of the asset, the asset medium, asset size, edition number, series, asset creator, the asset name, and the serial number or other asset identifier and other identifying information. Another embodiment may include the blockchain data or NFT metadata. In yet another embodiment, the Register may allow NFT minting. In another embodiment, it is the reduction of the opportunity for fraud or fakes in the sale of assets, where the assets are first authenticated on the Register before being listed for sale in a marketplace and are tied to a blockchain authenticated, immutable COA which is capable of prompt authentication in real time of the underlying asset using a mobile phone. In a further embodiment, the NFT data and the asset data are matched and consolidated into certificates or records of authenticity served to the asset viewer's mobile phone on interaction with the asset. In another embodiment, the certificate of authenticity is pulled from the NFT or NFT metadata itself, and not as separate strings of blockchain data. In another embodiment, it is a two-tier system for managing physical assets, an asset Register and an NFT marketplace, a system designed to limit and control the potential for physical assets to be transferred separately from their connected NFTs. In another embodiment, the marketplace is designed to connect to underlying assets. In another embodiment, the marketplace uses means and methods for sharing, and including resale rights, including where resale rights are embedded in the NFT metadata. In another embodiment, as part of the underlying asset connection maintenance, the Register NFTs are held by the Register, but blockchain mapped to the underlying asset, such that a transfer of the asset on the Register is blockchain recordable. In a further embodiment, the assets are cataloged and inventoried using the NFT itself allowing for a ‘universal catalog’ of blockchain authenticated assets, the NFT itself controlling the catalog entry that can transfer from one person's catalog to another on the transfer of the NFT. In another embodiment, the connection between the asset and the NFT is used to display rich content, including, augmented reality experiences on interaction with the asset, with this content and experiences being preserved and transferred with the NFT. In another embodiment, a wallet is used to hold physical assets and records relating to the physical asset. In another embodiment, the NFT is used to trade the underlying physical asset or to represent title in, or the right to call for delivery of the underlying physical asset. In yet another embodiment, the holding of physical assets via their connection to NFTs or other blockchain data allows for the aggregation of data concerning owner assets and preferences therefore, In another embodiment, a two-tier system, with a centralized component, for managing the physical asset and its connection with the NFT or digital record enhances the opportunities for data aggregation and marketing based on user preferences.

This invention discloses an inventory system which utilizes the NFT or the NFT metadata itself to populate and provide for an immutable and transferable asset inventory system. The system may use NFTs to authenticate physical assets through mobile phones or other devices and create a digital environment to inventory, authenticate, promote, purchase, and sell said assets.

The system may comprise a two-tiered method to accomplish the minting, management, cataloging, inventorying, promotion, authentication and buying and selling of physical NFT ownership interests, where the tiers may consist of a Register and a Marketplace.

The system includes an asset register and a digital marketplace for facilitating non-fungible token transactions, supporting beneficial ownership, dispute management, fractional ownership and inventorying of assets, and the holding of physical assets in digital wallets and the ability to identify and track ownership and ownership preferences by virtue of the assets held in a user's wallet, with accompanying opportunities to aggregate and commercialize data in relation thereto, and to target market accordingly.

Still, other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments.

Other embodiments may be used in addition or instead. Details which may be apparent or unnecessary may be omitted to save space or for more effective illustration. Some embodiments may be practiced with additional components or steps and/or without all the components or steps which are illustrated. When the same numeral appears in different drawings, it refers to the same or like components or steps.

FIG. 1 depicts a diagram of a method and a system for tying physical assets to digital assets and management thereof.

FIG. 2 depicts how a mobile device can be used to communicate with the NFC tag, alternatively, a QR code associated with the physical asset to provide user information, and physical asset information to a blockchain ledger or communicate with a NFC tag or QR Code to display asset information on the mobile device.

FIG. 3 depicts one embodiment of the method and system wherein a mobile phone can be used to capture the asset information, display asset information, or generate a certificate of authenticity of the physical asset tied to the non-fungible token.

FIG. 4 depicts the asset information of the physical asset or the non-fungible token as available on the blockchain ledger and displayed on the mobile phone as depicted in FIG. 3.

FIG. 5 depicts asset information as available on the NFT marketplace, particularly information regarding the physical asset and the non-fungible token associated with the physical asset, as displayed on the mobile phone depicted in FIG. 3.

### DETAILED DESCRIPTION

Before the method and system of the present invention are disclosed and described, it is to be understood that the method and system are not limited to specific methods, specific components, or particular implementations. It is also to be understood that the terminology used herein is for the purpose of describing particular embodiments only and is not intended to be limiting.

As used in the specification and the appended claims, the singular forms “a,” “an,” and “the” include plural referents unless the context dictates otherwise. Ranges may be expressed herein as from “about” one particular value, and/or to “about” another particular value. When such a range is expressed, another embodiment includes from one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, the nearness of completion will be to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the terms “approximately” and “about”, may refer to a deviance of between 0.001 and 40% from the indicated number or range of numbers.

The present disclosure includes the following numbered aspects:
1. A method for tying physical assets to digital assets and management thereof, the method including the steps of:
   i) entering at least one of user information and physical asset information into a mobile device or computer application;
   ii) associating a near field communication device or other identifier with the physical asset to tie at least one of the user information and the physical asset information to the physical asset;
   iii) uploading at least one of the user information and the physical asset information via the mobile application to a blockchain ledger to allow minting of a non-fungible token comprising, containing or referencing at least one of the user information and the physical asset information as asset information; and
   iv) transferring the non-fungible token into an asset register or wallet to allow for management of the physical asset tied to the non-fungible token, wherein the non-fungible token is the vehicle that allows for the management of the physical asset including at least one or a combination of owning, controlling, authenticating, cataloguing, inventorying, promoting and trading of the physical asset, wherein the non-fungible token (and its metadata) itself is the representation or store of information concerning the underlying physical assets (for, example, an artwork), comprising the information required to populate or create a certificate of authenticity for the asset, and which is transferable from one person to another and one inventory or cataloging system, account or wallet, to another.
2. The method of aspect 1, wherein the asset information is used to generate a certificate of authenticity inherent to the non-fungible token, during the management of the physical asset.
3. The method of aspect 1 or aspect 2, wherein the non-fungible token is linked through its metadata or otherwise dedicated URL for the non-fungible token to allow the display for at least one of the non-fungible tokens on a mobile device or a desktop format of rich content, the certificate of authenticity and asset information.
4. The method of aspect 1, wherein the asset information may be selected from the group consisting of physical asset care instructions; physical asset condition and wear; physical asset creation date; physical asset digital representation; physical asset dimensions and weight; physical asset identification number or serial number; physical asset maintenance and restoration history; physical asset manufacturing process or techniques; physical asset material composition; physical asset ownership transfer mechanism; physical asset packaging and preservation details; physical asset photographer or documenter; physical asset protection status such as insurance cover; physical asset registration status with relevant authorities; physical asset repair records; physical asset type and category; blockchain transaction record; creator or manufacturer's contact information; creator's digital signature; creator's name and biographical details; delivery or transportation method; digital twin of the physical asset; geolocation details during transport or display; intellectual property rights; certificate of authenticity; manufacturer's guarantee or warranty details; marketplace information; metadata describing digital records linked to the physical asset; ownership change history; ownership verification method; physical storage location and security details of the physical asset; provenance of the physical asset; quick response code (QR code), radio frequency identifications (RFID) tag, or other identifiers linked to the non-fungible token; related contractual agreements; restoration or conservation details of the physical asset; smart contract terms governing the non-fungible token; supply chain and logistics details; transaction timestamps for previous ownership; verification of originality or authenticity; and a combination thereof.
5. The method of aspect 1, wherein the non-fungible token allows for fractional ownership of the physical asset, and wherein the fractional ownership of the physical asset provides the retention of residual rights for populating a URL that is tied to and referenced in the non-fungible token with at least one of promotional information or content, further information or content regarding the physical asset, further information regarding the non-fungible token and
6. The method of aspect 1, wherein the asset information further comprises information obtained utilising image recognition that can be used to verify the accuracy of the physical asset when associating the physical asset with the non-fungible token.
7. The method of any one of the preceding aspects, wherein the non-fungible token represents the right to call for delivery of the physical asset.
8. A system for managing physical assets tied to non-fungible tokens comprising:—
   an asset register, wherein the asset register retains control of non-fungible tokens in the asset register that is associated with physical assets tied to the non-fungible tokens in accordance with any one of the preceding aspects whilst allowing transactions related to the non-fungible tokens to occur; and
   a digital marketplace for facilitating transactions of the non-fungible tokens registered on the asset register, wherein the digital marketplace is linked to the asset register via at least one of an application programming interface, the certificate of authenticity of the non-fungible tokens, the non-fungible tokens' metadata and the non-fungible tokens itself, wherein the register can adjust beneficial ownership of the non-fungible tokens tied to the physical assets.
9. The system of aspect 8, wherein the non-fungible token associated with the physical assets is held in a holder's wallet or account that is linked to the marketplace and the asset register, and wherein once a transaction has taken place it will register to a transferee's wallet or account to allow for at least one of owning, cataloging, authenticating, inventorying, managing, promoting the physical assets digitally via the non-fungible tokens in the wallet or account of the holder or the transferee, and for the aggregation of data concerning user preferences in relation to assets held in the user account or wallet.
10. The system of aspect 8, wherein the system allows for the correction of the beneficial ownership of the non-fungible tokens and the physical assets that are associated therewith if the physical assets are held by another person or were entered into the asset register by a person who is not the owner thereof.
11. The system of aspect 9 or aspect 10, wherein the register can release non-fungible tokens to the wallets of the owners or the wallets of designated individuals thereof if the register ceases to exist.
12. The system of aspect 8, wherein the certificate of authenticity comprises information selected from the group consisting of physical asset care instructions; physical asset condition and wear; physical asset creation date; physical asset digital representation; physical asset dimensions and weight; physical asset identification number or serial number; physical asset maintenance and restoration history; physical asset manufacturing process or techniques; physical asset material composition; physical asset ownership transfer mechanism; physical asset packaging and preservation details; physical asset photographer or documenter; physical asset protection status such as insurance cover; physical asset registration status with relevant authorities; physical asset repair records; physical asset type and category; blockchain transaction record; creator or manufacturer's contact information; creator's digital signature; creator's name and biographical details; delivery or transportation method; digital twin of the physical asset; geolocation details during transport or display; location of the physical asset, intellectual property rights; certificate of authenticity; manufacturer's guarantee or warranty details; marketplace information; metadata describing digital records linked to the physical asset; ownership change history; ownership verification method; physical storage location and security details of the physical asset; provenance of the physical asset; quick response code (QR code) or radio frequency identifications (RFID) tag, or other identifiers linked to the non-fungible token; related contractual agreements; restoration or conservation details of the physical asset; smart contract terms governing the non-fungible token; supply chain and logistics details; transaction timestamps for previous ownership; verification of originality or authenticity; and a combination thereof, wherein the information can be accessed via a linked URL from the marketplace or by physical interaction with the physical asset using at least one of a near field communication, image recognition, QR-codes or other identifiers that allow verification of the asset information and authenticity with reference to the non-fungible token as registered on the asset register.
13. The system of any one of aspects 8-12, wherein at least one of augmented reality experiences and other Rich Content are embedded in the URL associated with, and referenced in the non-fungible token to provide at least one of multi-media experiences, learning and promotional opportunities regarding the physical asset, and wherein the augmented reality experiences may be triggered by a predetermined value in the information stored as part of the certificate of authenticity of the non-fungible token, and wherein the augmented reality experiences and other Rich Content are transferable with the non-fungible token.
14. The system of any one of aspects 8-13, wherein the holding of physical assets via non-fungible tokens provides for opportunities for the aggregation of data, statistics or trends concerning user preferences or choices in relation to assets held in the user account or wallet, and the commercializion thereof.
15. Use of the system as in any one of aspects 8-14, wherein the system is used to register physical assets (for example, artwork) in the asset register to allow for trading thereof on a digital marketplace, and wherein the digital marketplace is a non-fungible token marketplace recorded on an immutable blockchain ledger.

Various embodiments are now described with reference to the drawings. In the following description, for purposes of explanation, numerous specific details are outlined in order to provide a thorough understanding of one or more embodiments. It may be evident, however, that the various embodiments may be practiced without these specific details. In other instances, well-known structures and devices are shown in block diagram form to facilitate describing these embodiments.

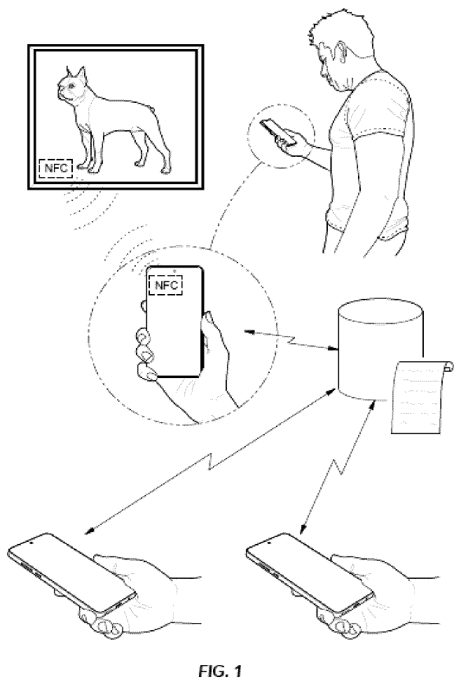

The present invention encompasses a system and method for managing physical assets by tying them to digital representations through Non-Fungible Tokens (NFTs), optimized for security and efficient asset management via blockchain technology. The entire method and system is exemplified with reference to FIG. 1 through FIG. 5, illustrating a pathway from data input to asset management on the blockchain:

FIG. 1 depicts a diagram of one embodiment of the invention, wherein the initial step is where users input comprehensive details about a physical asset into a mobile or computer application. This includes extensive information such as care instructions, condition and wear, creation date, digital representation, dimensions, weight, identification or serial number, maintenance and restoration history, manufacturing details, and material composition. Additional vital data includes ownership transfer mechanisms, packaging and preservation specifics, photographer or documenter details, insurance coverage, registration status with relevant authorities, repair records, asset type and category, and other metadata critical for blockchain transactions. An NFC device, preferably physically attached to the asset, is used to anchor these detailed records to the physical asset, thereby creating a digital identity on the blockchain. Once this data is gathered, it is uploaded to a blockchain ledger where an NFT that encapsulates all these details is minted. This NFT effectively becomes a digital twin of the physical asset, inclusive of important information such as the creator's name, contact details, biographical information, digital signature, and logistical details like delivery methods and geolocation during transport.

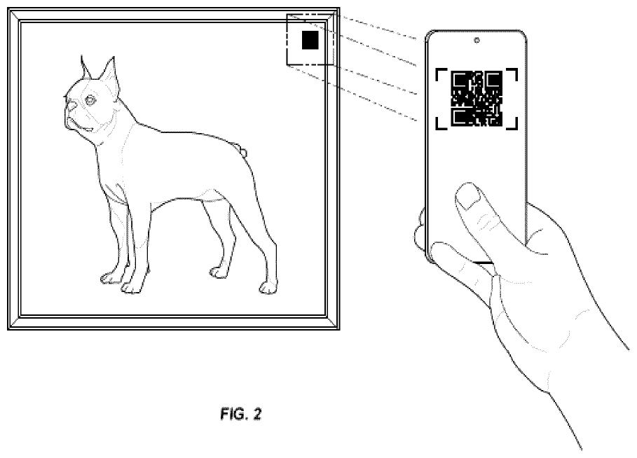

FIG. 2 demonstrates how this digital identity is interacted via a mobile device. By scanning the NFC or QR code attached to the physical asset, the user is connected to a dedicated URL hosting the Mobile Fine Art Experience™ integrated with the Fine Art Ledger (FAL) Register and Marketplace operating on blockchains like Polygon® and Ethereum®. This connection allows for real-time retrieval of the NFT metadata and the transaction history, ensuring that information such as the Certificate of Authenticity (COA) is current and accurate, maintaining a clear record of the asset's title, artist, dimensions, and provenance history.

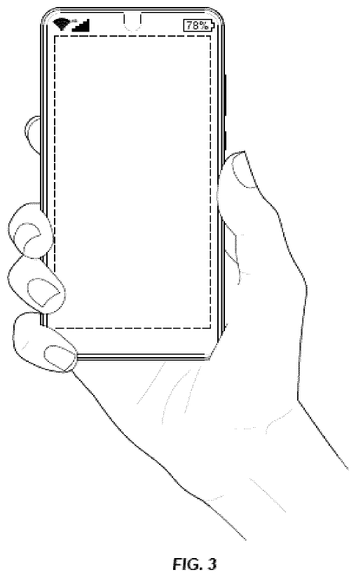

FIG. 3 shows what appears on a mobile device's screen post-interaction with the NFC or QR code. It displays the NFT's metadata and recent blockchain transaction hashes directly, allowing users to instantly verify the asset's authenticity and ownership history. This interface provides a user-friendly means to manage the provenance of physical assets, offering a secure and transparent method to access comprehensive asset information.

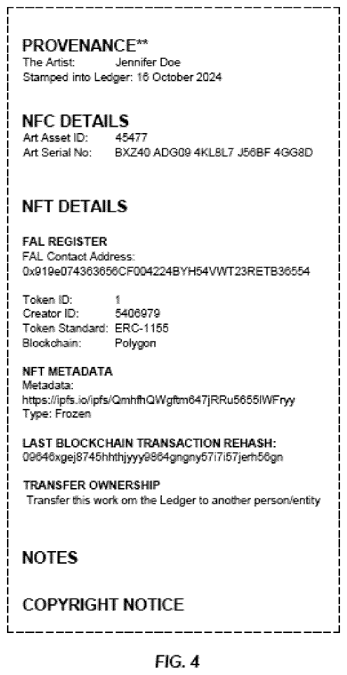

FIG. 4 depicts the details available on the blockchain ledger. It presents a screenshot showing the asset's NFT details such as the token ID, creator ID, blockchain standard, and direct links to the blockchain explorer. This ensures that all asset-related transactions or ownership changes are accurately recorded and that the status of the physical asset is always up-to-date and reflectively true on the blockchain ledger.

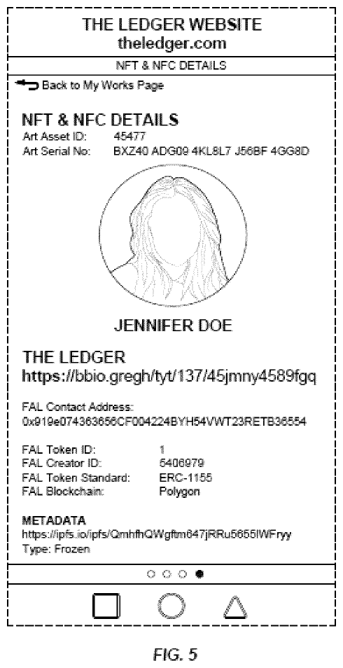

FIG. 5 depicts how the asset information integrates within the NFT marketplace. This marketplace displays detailed asset information and links directly to the FAL Register via APIs, supporting seamless transactions and updating the NFT's ownership according to marketplace activity. This digital marketplace allows for the trading of NFTs linked to physical assets, facilitating the buy and sell process without requiring the physical assets to change hands, thus simplifying the trading process and ensuring the assets remain secure.

The system and method of the present invention, as outlined in FIGS. 1-5 not only highlights a seamless process from data entry to the trading of digital representations on blockchain but also revolutionize how physical assets are held, owned, managed, cataloged, inventoried, and traded in a digital ecosystem. The integration of advanced blockchain technology like Ethereum® and Polygon® ensures a robust, secure framework that supports flexibility and broad accessibility in digital asset trading, offering a sophisticated solution to the management of tangible assets in the digital age.

What is claimed is:

1. A method for tying physical assets to digital assets and management thereof, the method including the steps of:
i) entering at least one of user information and physical asset information into a mobile device or computer application;
ii) associating a near field communication device or other identifier with the physical asset to tie at least one of the user information and the physical asset information to the physical asset;
iii) uploading at least one of the user information and the physical asset information via the mobile application to a blockchain ledger to allow minting of a non-fungible token comprising, containing, or referencing at least one of the user information and the physical asset information as asset information; and
iv) transferring the non-fungible token into an asset register or wallet to allow for management of the physical asset tied to the non-fungible token, wherein the non-fungible token is the vehicle that allows for the management of the physical asset including at least one or a combination of owning, controlling, authenticating, cataloguing, inventorying, promoting and trading of the physical asset,
wherein the non-fungible token itself is a representation or store of information concerning the underlying physical assets, comprising the information required to populate or create a certificate of authenticity for the asset, and which is transferable from one person to another, and/or from one inventory or cataloging system, account, or wallet, to another.

2. The method of claim 1, wherein the asset information is used to generate a certificate of authenticity inherent to the non-fungible token, during the management of the physical asset.

3. The method of claim 1, wherein the non-fungible token is linked through its metadata or otherwise dedicated URL for the non-fungible token to allow the display for at least one of the non-fungible tokens on a mobile device or a desktop format of rich content, the certificate of authenticity and asset information.

4. The method of claim 1, wherein the asset information may be selected from the group consisting of physical asset care instructions; physical asset condition and wear; physical asset creation date; physical asset digital representation; physical asset dimensions and weight; physical asset identification number or serial number; physical asset maintenance and restoration history; physical asset manufacturing process or techniques; physical asset material composition; physical asset ownership transfer mechanism; physical asset packaging and preservation details; physical asset photographer or documenter; physical asset protection status such as insurance cover; physical asset registration status with relevant authorities; physical asset repair records; physical asset type and category; blockchain transaction record; creator or manufacturer's contact information; creator's digital signature; creator's name and biographical details; delivery or transportation method; digital twin of the physical asset; geolocation details during transport or display; intellectual property rights; certificate of authenticity; manufacturer's guarantee or warranty details; marketplace information; metadata describing digital records linked to the physical asset; ownership change history; ownership verification method; physical storage location and security details of the physical asset; provenance of the physical asset; quick response code (QR code), radio frequency identifications (RFID) tag, or other identifier linked to the non-fungible token; related contractual agreements; restoration or conservation details of the physical asset; smart contract terms governing the non-fungible token; supply chain and logistics details; transaction timestamps for previous ownership; verification of originality or authenticity; and a combination thereof.

5. The method of claim 1, wherein the non-fungible token allows for fractional ownership of the physical asset, and wherein the fractional ownership of the physical asset provides the retention of residual rights for populating a URL that is tied to and referenced in the non-fungible token with at least one of promotional information or content, further information or content regarding the physical asset, further information regarding the non-fungible token and documentation.

6. The method of claim 1, wherein the asset information further comprises information obtained utilising image recognition that can be used to verify the accuracy of the physical asset when associating the physical asset with the non-fungible token.

7. The method of claim 1, wherein the non-fungible token represents the right to call for delivery of the physical asset.

8. A system for managing physical assets tied to non-fungible tokens comprising:
an asset register, wherein the asset register retains control of non-fungible tokens in the asset register that is associated with physical assets tied to one or more non-fungible tokens whilst allowing transactions related to the one or more non-fungible tokens to occur; and
a digital marketplace for facilitating transactions of the non-fungible tokens registered on the asset register, wherein the digital marketplace is linked to the asset register via at least one of an application programming interface, the certificate of authenticity of the one or more non-fungible tokens, the one or more non-fungible tokens' metadata and the one or more non-fungible tokens itself, wherein the register can adjust beneficial ownership of the one or more non-fungible tokens tied to the physical assets.

9. The system of claim 8, wherein the non-fungible token associated with the physical assets is held in a holder's wallet or account that is linked to the marketplace and the asset register, and wherein once a transaction has taken place it will register to a transferee's wallet or account to allow for at least one of owning, cataloging, authenticating, inventorying, managing, promoting the physical assets digitally via the non-fungible tokens in the wallet or account of the holder or the transferee, and for the aggregation of data concerning user preferences in relation to assests held in the holder's or tranferree's wallet or account.

10. The system of claim 8, wherein the system allows for the correction of the beneficial ownership of the non-fungible tokens and the physical assets that are associated therewith if the physical assets are held by another person or were entered into the asset register by a person who is not the owner thereof.

11. The system of claim 9, wherein the register can release non-fungible tokens to the wallets of the owners or the wallets of designated individuals thereof if the register ceases to exist.

12. The system of claim 8, wherein the certificate of authenticity comprises information selected from the group consisting of physical asset care instructions; physical asset condition and wear; physical asset creation date; physical asset digital representation; physical asset dimensions and weight; physical asset identification number or serial number; physical asset maintenance and restoration history; physical asset manufacturing process or techniques; physical asset material composition; physical asset ownership transfer mechanism; physical asset packaging and preservation details; physical asset photographer or documenter; physical asset protection status such as insurance cover; physical asset registration status with relevant authorities; physical asset repair records; physical asset type and category; blockchain transaction record; creator or manufacturer's contact information; creator's digital signature; creator's name and biographical details; delivery or transportation method; digital twin of the physical asset; geolocation details during transport or display; location of the physical asset, intellectual property rights; certificate of authenticity; manufacturer's guarantee or warranty details; marketplace information; metadata describing digital records linked to the physical asset; ownership change history; ownership verification method; physical storage location and security details of the physical asset; provenance of the physical asset; quick response code (QR code) or radio frequency identifications (RFID) tag, or other identifier linked to the non-fungible token; related contractual agreements; restoration or conservation details of the physical asset; smart contract terms governing the non-fungible token; supply chain and logistics details; transaction timestamps for previous ownership; verification of originality or authenticity; and a combination thereof, wherein the information can be accessed via a linked URL from the marketplace or by physical interaction with the physical asset using at least one of a near field communication, image recognition, QR-codes or other identifiers that allow verification of the asset information and authenticity with reference to the non-fungible token as registered on the asset register.

13. The system of claim 8, wherein at least one of augmented reality experiences and other Rich Content are embedded in the URL associated with, and referenced in the non-fungible token to provide at least one of multi-media experiences, learning and promotional opportunities regarding the physical asset, and wherein the augmented reality experiences may be triggered by a predetermined value in the information stored as part of the certificate of authenticity of the non-fungible token, and wherein the augmented reality experiences and other Rich Content are transferable with the non-fungible token.

14. The system of claim 8, wherein the holding of physical assets via non-fungible tokens is configured for aggregation of data, statistics or trends concerning user preferences or choices in relation to assets held in the user account or wallet, and the commercializion thereof.

15. A method of using the system of claim 8, comprising registering physical assets in the asset register to allow for trading thereof on a digital marketplace, and wherein the digital marketplace is a non-fungible token marketplace recorded on an immutable blockchain ledger.

16. The method of claim 2, wherein the non-fungible token is linked through its metadata or otherwise dedicated URL for the non-fungible token to allow the display of at least one of the non-fungible token on a mobile device or a desktop format of rich content, the certificate of authenticity and asset information.

17. The system of claim 10, wherein the register can release non-fungible tokens to the wallets of the owners or the wallets of designated individuals thereof if the register ceases to exist.

18. The system of claim 9, wherein at least one of augmented reality experiences and other Rich Content are embedded in the URL associated with, and referenced in the non-fungible token to provide at least one of multi-media experiences, learning and promotional opportunities regarding the physical asset, and wherein the augmented reality experiences may be triggered by a predetermined value in the information stored as part of the certificate of authenticity of the non-fungible token, and wherein the augmented reality experiences and other Rich Content are transferable with the non-fungible token.

19. The system of claim 10, wherein at least one of augmented reality experiences and other Rich Content are embedded in the URL associated with, and referenced in the non-fungible token to provide at least one of multi-media experiences, learning and promotional opportunities regarding the physical asset, and wherein the augmented reality experiences may be triggered by a predetermined value in the information stored as part of the certificate of authenticity of the non-fungible token, and wherein the augmented reality experiences and other Rich Content are transferable with the non-fungible token.

20. The system of claim 9, wherein the non-fungible token represents the right to call for delivery of the physical asset.
